(19) United States
(12) Patent Application Publication
(10) Pub. No.: US 2012/0167702 A1
(43) Pub. Date: Jul. 5, 2012

(54) GEAR MECHANISM

(76) Inventor: Hans-Michael Dangel, Erligheim (DE)

(21) Appl. No.: 13/390,321

(22) Filed: Feb. 13, 2012

(30) Foreign Application Priority Data
Aug. 13, 2009 (EP) PCT/EP2010/004935

(51) Int. Cl. F16H 35/10

(52) U.S. Cl. 74/405

(57) ABSTRACT

A gear mechanism for transmitting torques in both directions of rotation from a drive member driven in rotation to an output member arranged in the winding roller of a sun protection awning. Output member has a stop device with a hollow spindle connected to it, a travelling nut co-operating with hollow spindle and held non-rotatably thereon and stops for travelling nut. Output member is hollow and forms a unit at the end, remote from drive member. Housing of drive member is connected via first disengageable clutch to a guide tube for the non-rotatable retention of travelling nut in that it has a longitudinal groove in which a guide piece of travelling nut is guided. Drive member is connected via a second disengageable clutch to a drive shaft running freely in output member and hollow spindle. At its end, drive shaft is coupled to output member via a friction clutch.

### CROSS-REFERENCE TO RELATED APPLICATION

This application is a national stage application and claims the benefit of the priority filing date in PCT/EP2010/004935 referenced in WIPO Publication WO/2011/018223. The earliest priority date claimed is Aug. 13, 2009.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a gear mechanism as defined by the preamble to claim 1.

One such gear mechanism is known from German patent disclosure DE 1 876 411 A1. In it, external stops are preferably embodied in the form of spindle locks. They are used for limiting the travel distance of a sun protection awning, such as a blind or the like, on one or both sides.

These spindle locks for blinds are seated in the upper box of the blind and generally comprise a hollow spindle, which is provided with a thread and on which a traveling nut travels. Through a form lock with the upper box of the blind, the hollow spindle prevents a slaved rotation of the traveling nut while permitting an axial motion of the traveling nut. These spindle locks also comprise adjusting rings, mounted on both ends of the spindle, against which the traveling nut can stop. In general, the hollow spindle has an inner profile which is suited to being driven by the blind's turning rod. Thus, upon actuation of the blind, the hollow spindle rotates, while the traveling nut executes only an axial motion in the direction of the adjusting rings, and on reaching them prevents any further rotary motion. If the awning is fully extended, then the adjusting ring intended for this terminal position must be mounted in such a way that the traveling nut, in cooperation with the adjusting ring, makes further rotation of the awning in that direction impossible. The same procedure is repeated once the awning has been moved all the way upward in the opposite direction, i.e., to the desired terminal position. Adjusting the adjusting rings is done by means of screws on the adjusting rings. Calibrating the adjusting rings is complicated, both if they are preset in the factory and if they are recalibrated on the construction site. It is also difficult to achieve because of the sometimes poor accessibility of the shade systems.

In awnings and other kinds of shading means (such as roll-up shutters, shades, and the like, that are wound up onto windup shafts), the drive, in the form of a gear mechanism or motor, is generally located on one end of the windup shaft; on the other end—if necessary—the spindle lock is thrust axially into the windup shaft. The threaded spindles of such spindle locks do not rotate, and at the same time they serve as a bearing shaft for a tube adapter that is fixedly connected to the windup shaft. The traveling nut is connected to the windup shaft in such a way that it rotates with the windup shaft, and as a result, is axially movable in the winding tube.

When the windup shaft rotates, the traveling nut travels, for instance, in the direction of a stop fixedly connected to the threaded spindle, and the rotary motion is stopped as soon as the traveling nut reaches the stop..

A disadvantage of all spindle locks, both with motor operation and with manual operation by way of cranks, cords, or bead chains, is that they must sometimes withstand considerable forces, since, in the case of motors with a torque shutoff, the spindle locks are always subjected to the shutoff torque of the motor. In manual operation, even markedly greater forces can arise from improper or forceful use. To make it possible to ensure safe operation, the spindle locks must therefore be very sturdy and generously sized, and this sizing is associated with corresponding costs.

From German patent disclosure DE 43 28 698 A1, known is a gear mechanism for transmitting torques in both directions of rotation from a rotationally driven drive member to an output member that is connected to a shaft for raising a sun protection awning. The gear mechanism has a shiftable clutch device, by which the driving connection between these members can be disconnected in the upper or lower terminal position of the awning. However, in this case the gear mechanism is disposed in front of the awning, and the entire drive mechanism of the sunshade requires a. great deal of space. Since the load on the gear mechanism parts is limited to the forces that occur as the awning is raised and lowered, the gear mechanism parts can be lighter in weight and smaller, and can be made from weaker materials. Adjusting the terminal positions is easily done on site, but only because the gear mechanism is located in line with the awning and is therefore freely accessible.

The object of the present invention is to create a gear mechanism; of the type defined by the preamble to claim 1, in which an overload from either motor or manual operation in the terminal positions is made impossible, and which can be produced economically. The gear mechanism should allow for easy assembly both at the factory and on site, allow for easy adjustment of the terminal positions on site, enable an alternative option for use by simply pulling the awning out without shifting the terminal positions, and be installed in a space-saving way.

These objects are attained according to the invention by the characteristics of claim 1.

### SUMMARY

It can be seen that the invention is realized whenever the output member is embodied as hollow, like the hollow spindle, and on its end, remote from the drive member, forms a unit with the hollow spindle. The housing of the drive member is connected via a first disengageable clutch to a guide tube, which retains the traveling nut in a manner fixed against relative rotation by having a longitudinal groove, in which a guide rib of the traveling nut is guided. The drive member is connected via a second disengageable clutch to a drive shaft running freely in the output member and the hollow spindle. The drive shaft, on its end remote from the drive member, is coupled to the output member via a friction clutch.

Further expedient and advantageous embodiments of the invention will become apparent from the dependent claims.

All the gear mechanism parts, except for the helical brake spring of the friction clutch, can be made of plastic.

In a further embodiment of the invention, the hollow spindle has a male thread, and the traveling nut has a female thread.

In a further embodiment of the invention, the hollow spindle has a female thread, and the traveling nut has a male thread. Preferably, the hollow spindle and the traveling nut have metric threads.

In a further embodiment of the invention, the traveling nut, on its face end, has at least one stop cam, which cooperates with a stop on the face end of the output member.

In a further embodiment of the invention, on its outer end, for receiving the friction, clutch, the output member has an axial recess in which longitudinal ribs located side by side are disposed. The longitudinal ribs receive one end of a helical brake spring and cooperate with-the drive shaft of the friction clutch (26).

In a further embodiment of the invention, the output member, on its outer circumference, has a geometric shape for coupling to the windup shaft, which is embodied in complementary fashion for that purpose. In a further feature of the invention, it may be provided that the first disengageable clutch is formed by an axially or radially acting clutch.

In a further embodiment of the invention, the first disengageable clutch is formed by means of a disk connected to the guide tube and having at least one detent lug on the side toward the drive member. The first disengageable clutch is also formed by means of a perforated disk connected to the housing and provided in the vicinity of its circumference with circularly and uniformly distributed holes, which the detent lug (30) can engage.

In a further embodiment of the invention, a tool is provided for keeping the disk and the perforated disk apart.

In a further embodiment of the invention, the second disengageable clutch is formed by means of a coupling sleeve connected to the drive shaft, the coupling sleeve having an inner slaving portion and an inner freewheeling portion. The second disengageable clutch is also formed by means of a coupling rod that is connected to the drive member and engages the portions.

A further embodiment of the invention is designed such that the inner slaving portion has a reduced radius compared to the inner freewheeling portion and has three longitudinal grooves, whose bottoms rest on the radius of the inner freewheeling portion. The invention is also designed such that the coupling rod has three cams, distributed over its circumference, for engagement with the longitudinal grooves.

As a result, the following simple process of assembly and adjustment is possible: at the factory assembly site, the gear mechanism with the stop device is built according to the invention into the windup shaft. On the windup shaft, the awning has already been fully wound up, and in such a way that the traveling nut is located at the stop of the output member. Therefore, upon actuation of the output member, the awning can not be extended, since the stop device is at one terminal position at the stop and would trip the friction clutch. This ensures, that the awning is secured during shipping. The windup shaft, together with the awning, and the gear mechanism, together with the stop device, can now be built into the complete system at the factory. It can then be packed and shipped to the construction site.

There, the complete system is mounted on the building. By means of a suitable actuating mechanism, the output member is released from the drive member, and the system is moved downward by means of the drive member until it is in the desired terminal position. As described above, the entire stop device rotates together with the windup shaft, so that the traveling nut remains at the stop and does not execute any axial motion.

Alternatively, the awning can be pulled out by hand to the desired lower terminal position, with the output member released. Since the drive member in the form of a gear mechanism or motor generally has a brake, the friction clutch slips when the awning is pulled out. The advantage of this type of adjustment is that the mechanic can adjust the lower terminal position while a user control element, such as a crank or an electrical supply to the motor, is not yet in place.

In the lower terminal position, the output member is fixedly connected to the drive member again via the aforementioned actuating mechanism. As a result, the end stop is in this terminal position as well, thus concluding the adjustment of the terminal position. If the awning is then moved upward by means of the drive member, the traveling nut moves axially away from the stop, as intended, on the thread of the spindle.

The release and connection of the output member from and to the drive member can be done, for instance, by means of a releasable, axially unlatchable connection: between the drive member and the output member.

A two-part fixed stop is also advantageous. The first part is then fixedly connected to the drive member and the second part is rotatably supported and releasably connected to the first part. By means of a blocking member, such as a set screw, the rotary motion can either be prohibited or permitted.

An actuating mechanism in the form of a lever, pushbutton, or rotary disk may be provided, with which an axial or radial form lock between a first, fixed part of the output member and a second, rotatably supported part of the output member, can be axially or radially engaged or disengaged. The disengagement motion can be effected by means of a cam disk, tapered slide valve or blocking member on the actuating mechanism, for example, which disk or valve or blocking member is moved counter to an axial spring force, or radially.

### FIGURES

The invention will now be described in further detail in terms of exemplary embodiments. In the drawings:

FIG. 1 is a complete sectional view of the version with a female thread on the traveling nut;

FIG. 2 is a complete sectional, view of an alternative version with a male thread on the traveling nut;

FIG. 3 shows various views of the gear mechanism of FIG. 1;

FIGS. 4-6 show various views of the traveling nut;

FIGS. 7-9 show various views of the stop tube used in FIG. 1;

FIGS. 10-12 show various views of the drive shaft used in FIG. 1;

FIGS. 13-15 show various views of the guide tube used in FIG. 1;

FIGS. 16-18 show various views of the brake cylinder used in FIG. 1;

FIGS. 19-21 show various views of the helical brake spring used in FIG. 1;

FIG. 22 shows views of the drive member used in FIG. 1;

FIG. 23 is a perspective view of the gear mechanism of the invention, with a first disengageable clutch in the unlatched adjustment position;

FIG. 24 is a perspective view of the gear mechanism of FIG. 23, in which the first disengageable clutch is in the latched operating position;

FIG. 25 shows various views of the disk, used in FIGS. 23, 24, of the first disengageable clutch having the guide tube;

FIG. 26 shows various views of the perforated disk used in FIGS. 23, 24;

FIG. 27 shows various views of the spacer tab;

FIG. 28 shows an exploded view in perspective of the gear mechanism of FIGS. 23, 24;

FIG. 29 is an enlarged perspective sectional view of the second disengageable clutch, shown in FIG. 28, in the engaged position and of the drive shaft;

FIG. 30 is an enlarged perspective sectional view of the second disengageable clutch, shown in FIG. 28, in the disengaged, position and of the drive shaft; and

FIG. 31 is a perspective sectional view of the gear mechanism of FIGS. 23, 24.

### LIST OF REFERENCE NUMERALS

1 Drive shaft

2 Drive member

3 Traveling nut

4 Guide rib

5 Guide groove

6 Guide tube

7 Detent means

8 Receptacle

9 Female thread

10 Stop cam

11 Stop

12 Stop tube

12₁ Output shaft

12₂ Spindle

13 Male thread

14 Slaving groove

15 Annular shoulder

16 Inner circumference

17 Spring end

17′ Spring end

18 First square

19 Brake cylinder

20 Plunge cut

21 Second square

22 Disk

23 Friction clutch side

24 Receiving means

25 Helical brake spring

26 Friction clutch

27 Disk

28 Perforated disk

29 Spacer tab

30 Detent lug

31 Flange

32 Seeger ring

33 Side

34 Hole

35 Protrusion

36 Side

37 Opening

38 Intermediate slaving tube

39 (unassigned)

40 Open end (of the spacer tab)

41 Claw

42 Eye

43 Coupling sleeve

43₁ Inner slaving portion

43₁ Inner freewheeling portion

44 Coupling rod

44₁ Cam

45 Longitudinal groove

### DETAILED DESCRIPTION

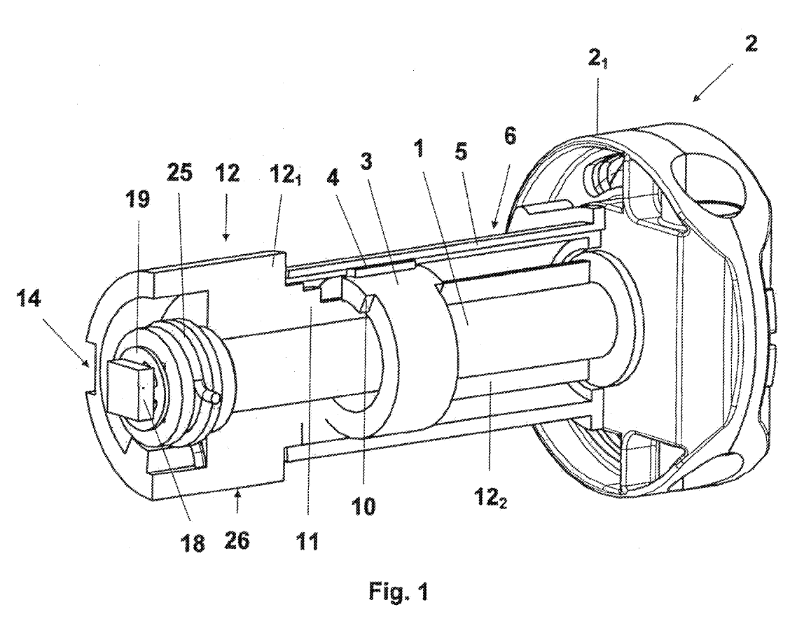

In FIG. 1, a complete view of the gear mechanism with the stop device according to the invention can be seen in sectional view. A drive member 2 is connected to a drive shaft 1 in a manner fixed against relative rotation, as a result of which the rotary motion of the drive member is transmitted to the drive shaft 1. The drive shaft 1, on its end remote from the output member 2, is coupled with a stop tube 4 via a friction clutch. The friction clutch has a helical brake spring 25, which is seated on a brake cylinder and the spring ends of which are retained in the output member 12₁. The brake cylinder 19 is seated in turn on a first square 18 on the left-hand end of the drive shaft 1 and is retained there. The stop tube 12 receives the drive shaft 1 and comprises two tube portions 12₁ and 12₂. The first tube portion receives the helical brake spring 25 and is called an output member 12₁ because it is coupled on its circumference by means of a groove 14 to the winding tube, not shown, and is provided on its face end toward the drive member 2 with a stop 11. The second tube portion, adjoining the output member 12₁ in the direction of the drive member 2, receives the drive shaft 1, is embodied as a spindle 12₂, and cooperates on the threaded side of the spindle with a traveling nut 3 that has a female thread. When the drive shaft 1 rotates, the traveling nut 3 moves in a corresponding axial direction to a preset stop. This axial motion of the traveling nut 3 is possible because the traveling nut 3 has a guide rib 4, which is guided in a complementary guide groove 5 of a guide tube 6 connected to the housing 2₁ of the drive member 2 and is thus prevented from executing a rotary motion. On the face end, remote from the drive member 2, the traveling nut 3 has a stop cam 10. If the traveling nut 3, with its stop cam 10, has run up against the stop 11, then if the user exerts great force, the helical brake spring 25 is tripped; that is, a widening of the helical brake spring 25 uncouples the drive shaft 1 from the stop tube 12, thus preventing an overload on the drive train or on the awning. If a double brake spring is used, as is known from European patent disclosure EP 09001269, then there can be a different predetermined tripping torque in every direction of rotation.

By combining the stop device with an overload clutch, i.e., the friction clutch 26, it is possible for the awning, such as a roll-up shutter, to be pulled out by hand, despite a nonmoving or blocked drive member 2. Pulling on the roll-up shutter sets the stop tube 12 into rotation. In the process, the helical brake spring 25 of the friction clutch slides on the drive shaft 1, since the drive shaft 1 is blocked by the drive member 2, which is generally self-locking. The traveling nut 3 nevertheless continues to move until the stop cam 10 runs up against the stop 11 and blocks the motion. What is decisive is that the terminal positions are not shifted, both when the awning is operated by means of the drive member 2 and when it is operated by being pulled.

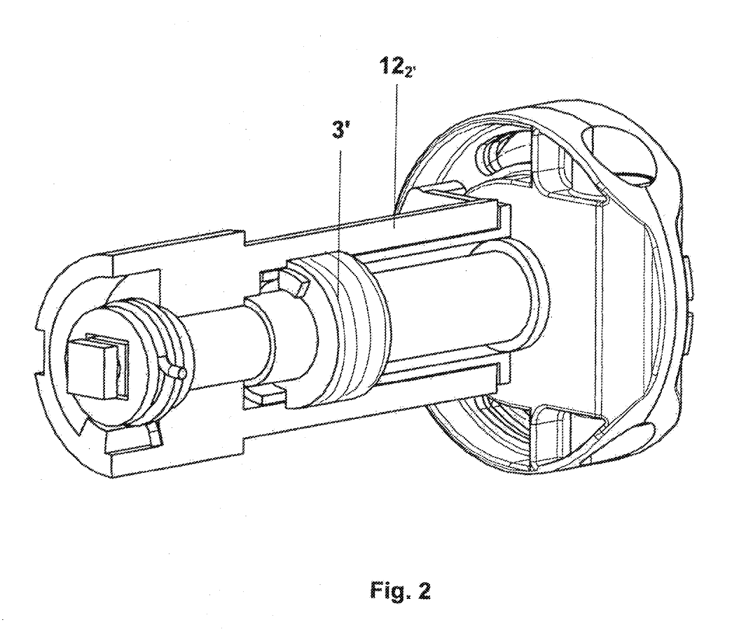

In FIG. 2, an alternative version of the gear mechanism is shown, which functions in the same way as the version describe above, but differs in its construction. Here, the thread on the traveling nut 3′ is provided on the outside, while the spindle 12₂′ has a female thread.

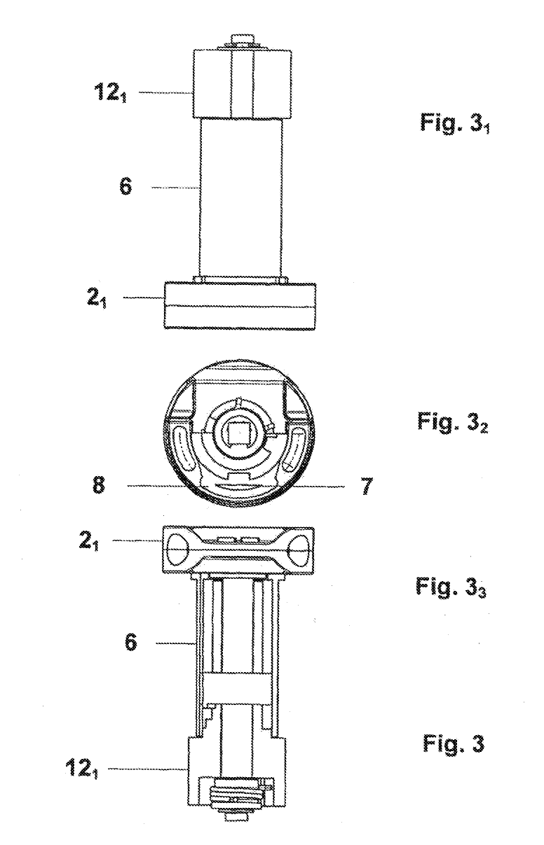

In FIG. 3, a. first version of the gear mechanism is shown; specifically, FIG. 3₁ shows a side view, FIG. 3₂ shows an end view of FIG. 3, from above, and FIG. 3₃ shows a longitudinal section through FIG. 3₁. Here, it can easily be seen how a detent means 7 of the guide tube 6 is connected to a receptacle 8 in the housing 2₁.

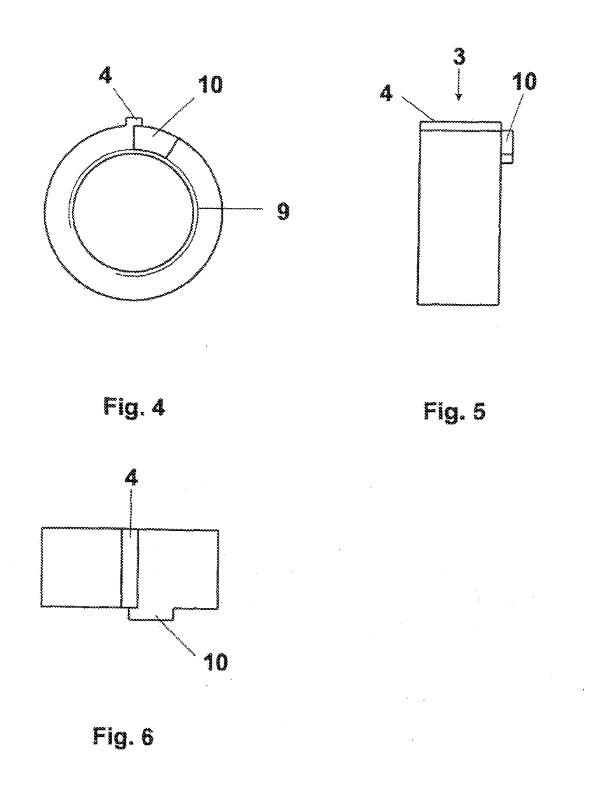

In FIGS. 4-6, the traveling nut 3 is shown with a female thread 9, a guide rib 4, and a stop cam 10. With its guide rib 4, the traveling nut 3 runs in the guide groove 5 of the guide tube 6, so that a rotary motion of the traveling nut 3 is prevented, and an axial motion is generated. Once the travel distance has been covered in once direction, the stop cam 10 collides with the stop 11 of the output member 12₁.

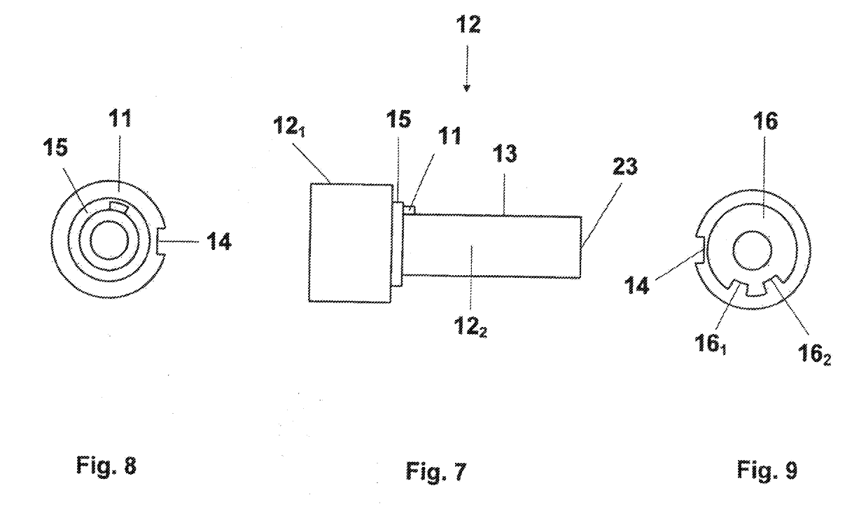

In FIGS. 7-9, the stop tube 12 is shown with the spindle 12₂, which has a male thread 13 and is compatible with the female thread 9 of the traveling nut 3. The stop 11, which collides with the stop cam 10 of the traveling nut 3, and a slaving groove 14, which is compatible with an inner rib of the windup shaft (not shown) of the awning, are also shown. Instead of the slaving groove 14, any other geometric shape that is complementary to the windup shaft of the awning is conceivable. Also shown are longitudinal grooves 16₁ and 16₂ on the inside circumference of the output member 12₁, which serve to receive spring ends 17, 17′ of the helical brake spring 25. Reference numeral 15 indicates an annular shoulder of the output member 12₁, while 23 indicates the end of the friction clutch.

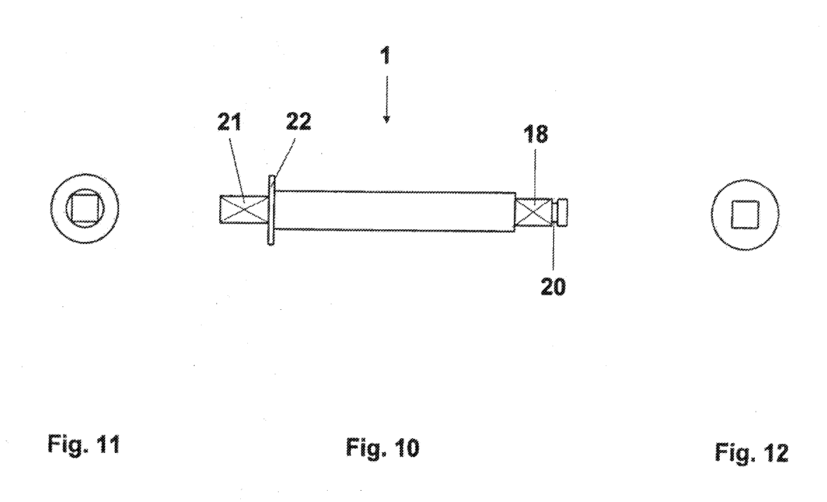

In FIGS. 10-12, the drive shaft 1 is shown with a first square 18, disposed on the right-hand end, for receiving a brake cylinder 19, which is fixed on a plunge cut 20 of the square 18 by means of a Seeger ring (32) not shown in these drawings. On the opposite end of the drive shaft 1 is a second square 21, which serves as a drive receptacle for the drive member 2. Depending on how the drive member 2 is embodied, the second square 21 can be embodied as a hexagon instead, or it may have any other shape that is complementary to the drive member 2. The manner in which the second square 21 is fixed is not shown. It can be fixed by means of screws or clips or by some, other conceivable type of fastening. A disk 22 serves as an axial fixation of the drive shaft 1 in the output member 12₁.

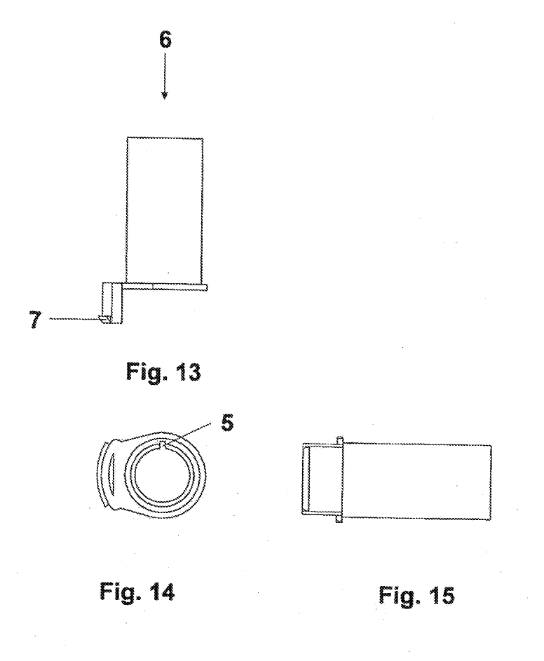

In FIGS. 13-15, the guide tube 6 is shown with its detent means 7, which acts in complementary fashion to the receptacle 8 of the drive member 2. The groove 5, which serves to receive the guide rib 4 of the traveling nut 3, can also be seen here.

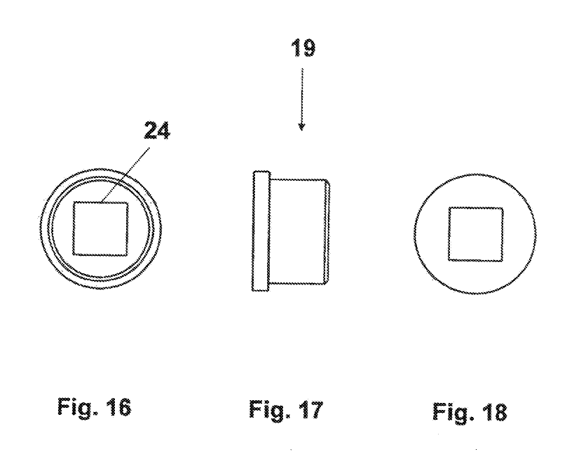

In FIGS. 16-18, the brake cylinder 19 can be seen, with a receiving means 24 that serves the purpose of complementary introduction of the first square 18 of the drive shaft 1. Once again, for both the receiving means 24 and the first square 18, any conceivable complementary geometric shape can be employed.

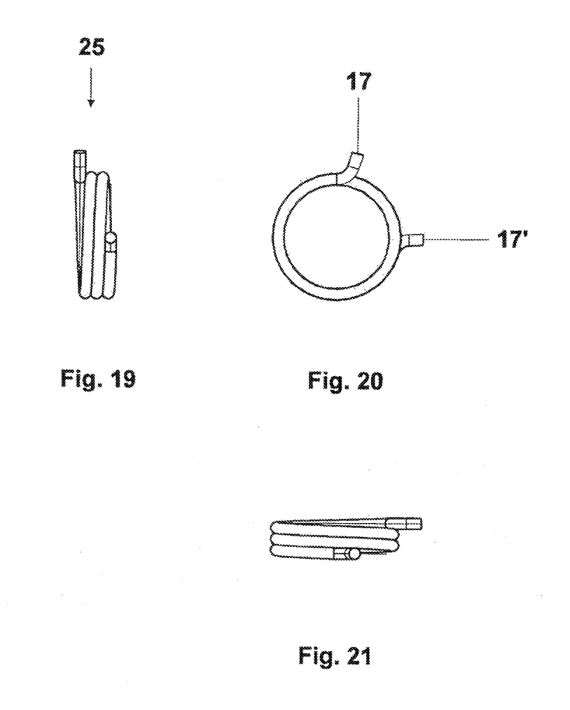

In FIGS. 19-21, the helical brake spring 25 is shown with its ends 17 and 17′. Together with the brake cylinder 19, it forms a friction clutch and thus an overload clutch.

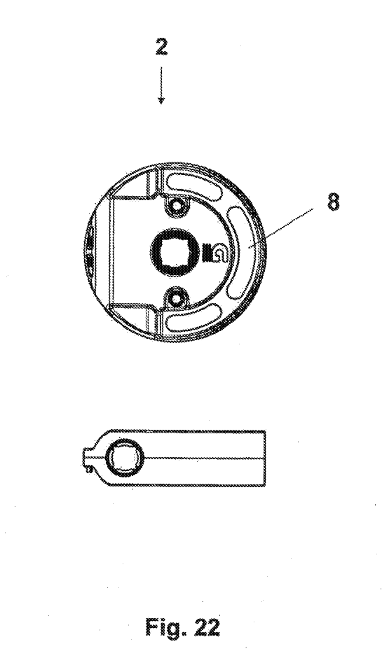

In FIG. 22, the drive member 2 is shown with its receptacle 8 as an example. The receptacle can have a different shape, depending on how the drive member is embodied.

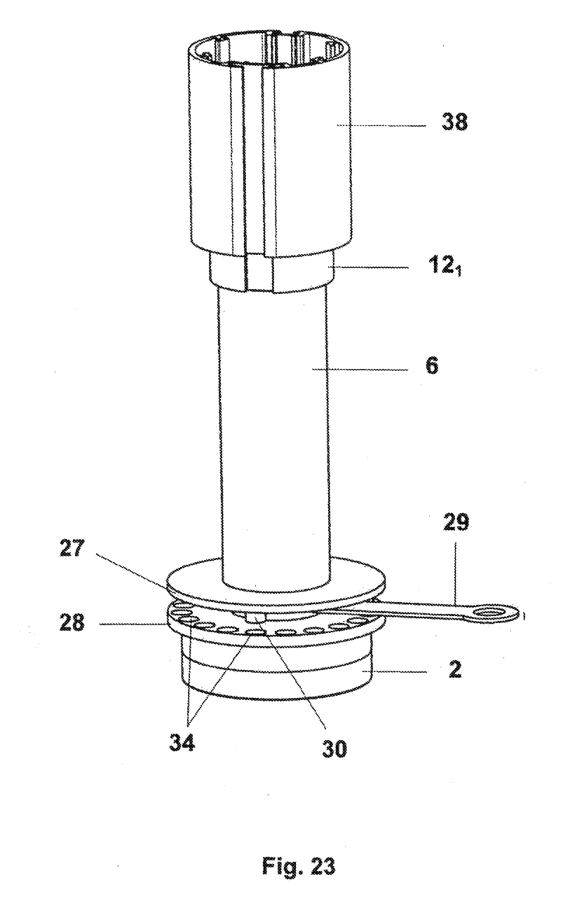

In FIG. 23, one version of the gear mechanism with a stop device according to the invention is shown. However, in a departure from FIGS. 1-22, the gear mechanism is provided with disengageable clutches on the drive end and with an intermediate slaving tube 38 on the output member 121. In FIG. 23, a first disengageable clutch is shown, which comprises a disk 27, which is fixedly connected to the guide tube 6 and may also be a flange of this guide tube, and a perforated disk 28 connected to the housing 21. The disk 27 has at least one detent lug 30 in the vicinity of its circumference, on the side toward the drive member 2. The perforated disk 28, in the vicinity of its circumference, has holes 34, distributed over that circumference, whose diameters are adapted to the diameter of the detent lug 30. The detent lug 30 can penetrate these holes 34 and thus couple the two disks to one another. FIG. 23 shows the two disks in the disengaged state, in which the terminal positions can be adjusted. To maintain the disengaged state, a tool in the form of a spacer tab 29 is used. The disengagement is effected, in the example shown in the drawing here, by pulling the disk 27 and the perforated disk 28 apart and thrusting the spacer tab 29 between them to fix this position.

Further advantageous features of the invention for disengaging and fixing the disk 27 on the perforated disk 28 are not shown; for instance, the position is fixed by means of a tension spring or a kind of bayonet mount or a fixedly mounted clamping lever.

In a further advantageous version of the invention, not shown in detail, the detent lugs 30 on the disk 27 can be dispensed with, in favor of recesses and protrusions disposed radially on the circumference in the manner of a set of spur gear teeth. To that end, the perforated disk 28 at least has a partly complementary radial counterpart contour in the manner of an internal geared wheel, in which case the holes 34 can be dispensed with. This creates an axially disengageable and engageable clutch with radially acting teeth.

As another advantageous embodiment not shown, the perforated disk 28 is dispensed with in favor of a receptacle which is fixedly connected to the drive member 2 and has a radially positionable blocking member, which can be made to engage and disengage from the above-described spur gear teeth of the disk 27.

As another advantageous embodiment not shown, the disk 27, instead of the spur gear teeth, has a cylindrical jacket face, which is acted upon by the aforementioned blocking member, for instance, in the form of a set screw acting radially on the jacket face and thus either fixes the disk 27 or permits a rotary motion.

An axial detent connection between the drive shaft 1 and the output member 2 of the gear mechanism is also advantageous. It is dimensioned such that two defined axial positions are obtained, corresponding to the engaged or disengaged position of the disk 27. The engagement and disengagement operation can be done by hand, by axially shifting the windup shaft. This version will be described in further detail below.

These additional embodiments of the above-described invention have the advantage that a “loose” tool, like the spacer tab 29, is no longer necessary.

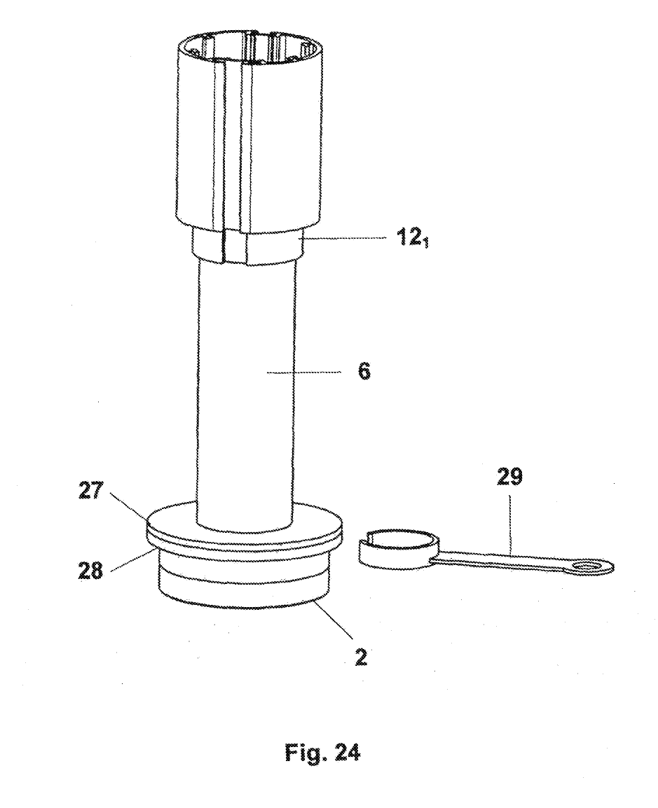

In FIG. 24, the clutch 27, 28 shown in FIG. 23 is shown in the engaged state, or, in other words, in the normal operating state.

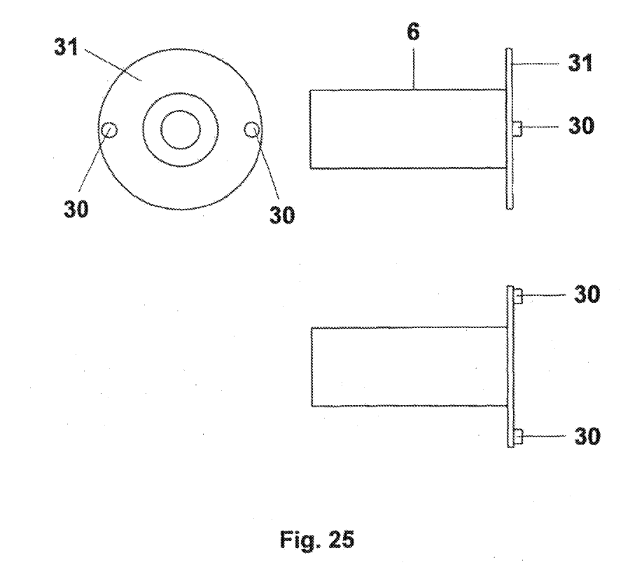

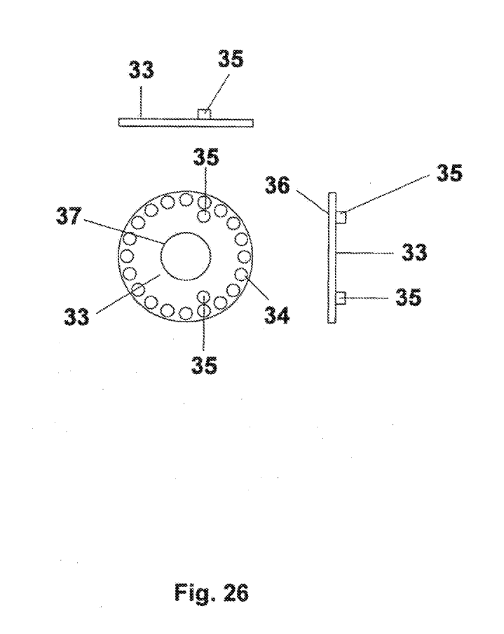

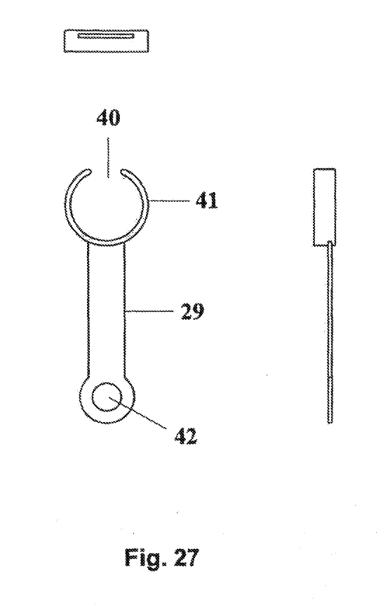

In FIGS. 25-27, the requisite individual parts for the version of the gear mechanism shown in FIGS. 23 and 24 are shown. In FIG. 25, views are shown of the guide tube 6 and the disk 27 embodied as a flange 31. In FIG. 26, views of the perforated disk 28 are shown. The perforated disk 28, on the side 33 toward the drive member 2, has two protrusions 35 and a central, round opening 37. These means serve to fix the perforated disk 28 to the housing 2₁. The side of the perforated disk toward the drive member is indicated by the numeral 36. In FIG. 27, views of the spacer tab 29 are shown. The spacer tab 29 is in the form of a flat lever, which is provided on one end with a claw 41 that has an open end 40 and on the other end with an eye 42.

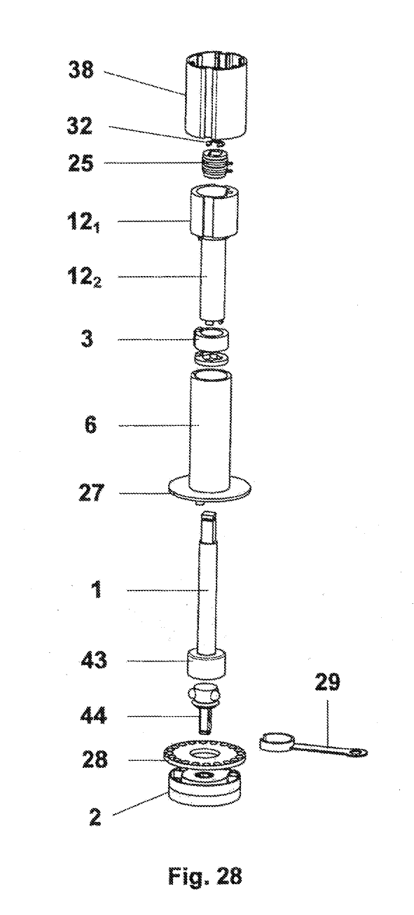

In FIG. 28, an exploded view of the gear mechanism of FIGS. 23, 24 is shown. Besides the first disengageable clutch 27, 28, a second disengageable clutch can be seen, which comprises a coupling sleeve 43 connected to the drive shaft 1 and a coupling rod 44 that engages this coupling sleeve.

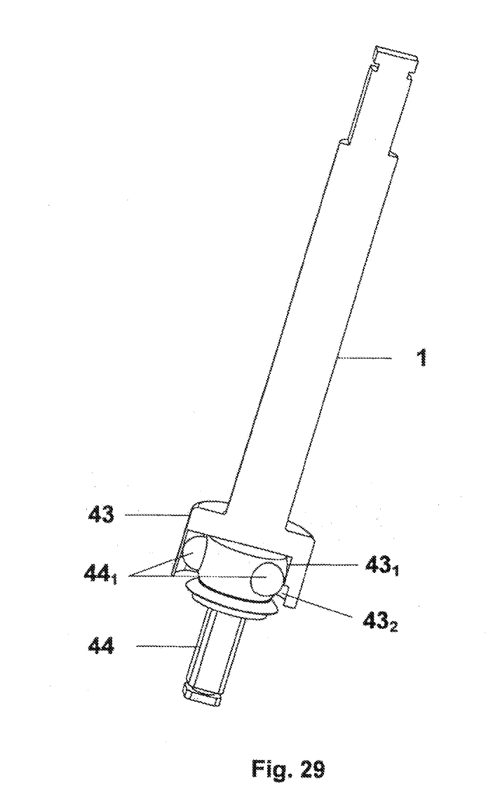

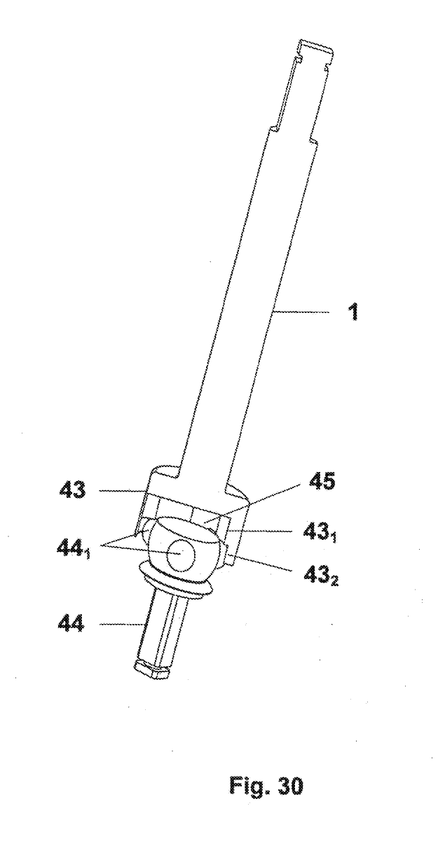

Enlarged views of this second disengageable clutch are shown in FIGS. 29 and 30. The coupling sleeve 43 has inner portions, namely an inner slaving portion 43₁ and a inner freewheeling portion 43₂. The inner slaving portion 43₁ has a reduced radius compared to the inner freewheeling portion 43₂ and also has three longitudinal grooves 45, distributed over the inside circumference, whose bottoms rest on the radius of the inner freewheeling portion 43₂. The coupling rod 44 is provided with three cams 44₁, distributed over its circumference, for engagement with the longitudinal grooves 45. In FIG. 29, the cams 44₁ have engaged the grooves 45, while in FIG. 30 they are disengaged.

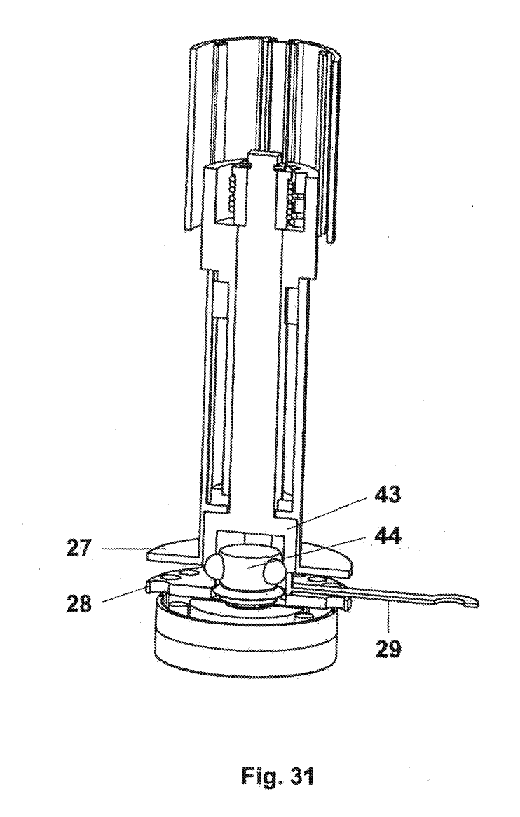

In FIG. 31, finally, the gear mechanism of the invention is shown in section with the first disengageable clutch 27, 28 and the second disengageable clutch 43, 44.

What is claimed:

1. A gear mechanism, having a drive member (2) and an output member (12₁) that is disposed in the windup shaft of a sun protection awning and has a stop device, which has a hollow spindle (12₂), a traveling nut (3) cooperating with the hollow spindle, and stops (10, 11) for the traveling nut, wherein
the output member (12₁) is embodied as hollow;
the housing (2₁) of the drive member (12₁) is connected via a first disengageable clutch (27, 28) to a guide tube (6), which performs the retention of the traveling nut (3) in a manner fixed against relative rotation;
the gear mechanism has a longitudinal rib (5), in which a guide rib (4) of the traveling nut (3) is guided;
the drive member (2) is connected via a second disengageable clutch (43, 44) to a drive shaft (1) running freely in the output member (12₁) and the hollow spindle (12₂); and
the drive shaft (1), on its end remote from the drive member (2), is coupled to the output member (12₁) via a friction clutch (26).

2. The gear mechanism as defined by claim 1 for transmitting torques in both directions of rotation from the drive member (2) driven in rotation to the output member (12₁) that is disposed in the windup shaft of a sun protection awning and has a stop device which has a hollow spindle (12₂) fixedly connected to the output member (12₁), a traveling nut (3) that cooperates with the hollow spindle and is retained in a manner fixed against relative rotation, and stops (10, 11) for the traveling nut, wherein
the output member (12₁) is embodied as hollow like the hollow spindle, and on its end remote from the drive member (2) forms a unit with the hollow spindle.

3. The gear mechanism as defined by claim 1, wherein the hollow spindle (12₂) has a male thread, and the traveling nut (3) has a female thread.

4. The gear mechanism as defined by one of claims 1, wherein the hollow spindle (12₂) has a female thread, and the traveling nut (3′) has a male thread.

5. The gear mechanism as defined by one of claims 1, wherein the hollow spindle (12₂, 12₂) and the traveling nut (3, 3′) have metric threads (9).

6. The gear mechanism as defined by one of claims 1, wherein the traveling nut (3), on its face end, has at least one stop cam (10), which cooperates with a stop (11) on the face end of the output member (12₁).

7. The gear mechanism as defined by one of claims 1, wherein, for receiving the friction clutch (26), the output member (12₁) has an axial recess (16) on its outer end, in which recess longitudinal ribs (16₁, 16₂) located side by side are disposed for receiving one end of a helical brake spring (25), which cooperates with the drive shaft (1), of the friction clutch (26).

8. The gear mechanism as defined by one of claims 1, wherein the output member (121), on its outer circumference, has a geometric shape (14) for coupling to, the windup shaft, which is embodied in complementary fashion for that purpose.

9. The gear mechanism as defined by one of claims 1, wherein the first disengageable clutch is formed by means of a disk (27) connected to the guide tube (6) and having at least one detent lug (30) on the side toward the drive member (2) and by means of a perforated disk (28) connected to the housing (21) and provided in the vicinity of its circumference with circularly and uniformly distributed holes (34), which the detent lug (30) can engage.

10. The gear mechanism as defined by claim 9, wherein a tool (29) is provided for keeping the disk (27) and the perforated disk (28) apart.

11. The gear mechanism as defined by one of claims 1, wherein the second disengageable clutch is formed by means of a coupling sleeve (43) connected to the drive shaft (1), the coupling sleeve having an inner slaving portion (43₁) and an inner freewheeling portion (43₂), as well as by means of a coupling rod (44) connected to the drive member (2), which coupling rod engages the portions (43₁, 43₂).

12. The gear mechanism as defined by claim 11, wherein the inner slaving portion (43₁) has a reduced radius compared to the inner freewheeling portion (43₂) and has three longitudinal grooves (45), whose bottoms rest on the radius of the inner freewheeling portion (43₂); and the coupling rod (44) has three cams (44₁), distributed over its circumference, for engagement with the longitudinal grooves (45).
